(19) United States
(12) Patent Application Publication
(10) Pub. No.: US 2009/0299879 A1
(43) Pub. Date: Dec. 3, 2009

(54) Catalog Builder with an Expert System

(76) Inventor: Jianhua Lu, New York, NY (US)

Correspondence Address: Jianhua Lu, Rm 405, 246 5th Ave., New York, NY, 10001, US

(21) Appl. No.: 12/477,832

(22) Filed: Jun. 3, 2009

Related U.S. Application Data
(60) Provisional application No. 61/058,501, filed on Jun. 3, 2008.

(51) Int. Cl. G06Q 30/00

(52) U.S. Cl. 705/27

(57) ABSTRACT

A Catalog Builder that has a built-in Expert System which assists Catalog Builder operators in catalog building. The Expert System contains a knowledge database that stores keywords that can be used to describe a product or help a product get discovered during a search, and, optionally, the definitions of those keywords. The Expert System has one main function: it makes keyword suggestions to Catalog Builder operators during a product information submission process. The Expert System can also have a second function, which is to acquire product knowledge from Catalog Builder operators by adding new keywords that have been entered by Catalog Builder operators during a product information submission process to the knowledge database, or by allowing Catalog Builder operators add new keywords and optionally, their definitions, to the knowledge database during a catalog building process.

### REFERENCE TO RELATED APPLICATION

This patent application claims the benefit of U.S. Provisional Application No. 61/058,501 filed on Jun. 3, 2008 the disclosure of which is incorporated herein by reference in its entirety.

### BACKGROUND OF THE INVENTION

1. Field of the Invention

The present invention relates generally to the field of catalog creation and, more specifically, to methods for preparing a catalog.

2. Description of the Related Art

Businesses constantly need to inform potential customers of the goods they have for sale. This need is met by publishing a catalog. Catalogs are sometimes written by catalog writers, sometimes built by catalog builders. A catalog builder is a software application or a web application that is built for the preparing of product catalogs.

When catalogs are prepared by catalog writers or catalog builders, information about the products in a catalog is written by the catalog writers or entered by the catalog builder operators based on their own knowledge of the type of products in the catalog, using their own vocabulary. Therefore, the quality of the catalog depends largely on catalog writers or catalog builder operators' knowledge of the type of products in the catalog and their vocabulary.

A catalog writer or a catalog builder operator with limited knowledge of the type of products in a catalog may produce a catalog with incomplete information about the products in the catalog. A shopper, when buying from a catalog with incomplete information about the products, may have difficulty in making a decision on the purchase of a product. This lack of information about the products in a catalog can result in lost sales.

Because there is often time no industry wide standard that has to be followed in communicating product information to a perspective buyer, a catalog writer or a catalog builder operator with a limited vocabulary may produce a catalog with ambiguous information about the products in the catalog. This can result in a miscommunication of product information, which can result in lost sales or returns of merchandize after purchases.

The limited vocabulary of the catalog writers or the catalog builder operators of an electronic catalog or an online catalog may also result in the lack of keywords that can help the products in the catalog get discovered during a search. A seller often time carry a large number of products each of which is identified with a serial number and a description written by catalog writers or entered by catalog builder operators. The lack of keywords in the products' descriptions in an electronic catalog or an online catalog makes it difficult for electronic catalog shoppers or online shoppers to find a specific product through searches. This can also result in lost sales.

### SUMMARY OF THE INVENTION

Catalog Builder with an Expert System is a catalog builder that has a built-in expert system. The Expert System contains a knowledge database that stores keywords that can be used to describe a product or help a product get discovered during a search, and, optionally, the definitions of those keywords. The Expert System has one main function: it draws keywords from the knowledge database and presents them to the Catalog Builder operators to be selected and added to the description of a product or assigned to a product during a product information submission process. The Expert System can also have a second function, which is to add new keywords that have been entered by Catalog Builder operators during a product information submission process to the knowledge database, or to allow Catalog Builder operators add new keywords and optionally, their definitions, to the knowledge database during a catalog building process, although keywords and their definitions can also be added to the knowledge database by administrators of the Expert System independent from any catalog building process.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

Other aspects, features, and advantages of the present invention will become more fully apparent from the following detailed description, the accompanying drawing, and the appended claim.

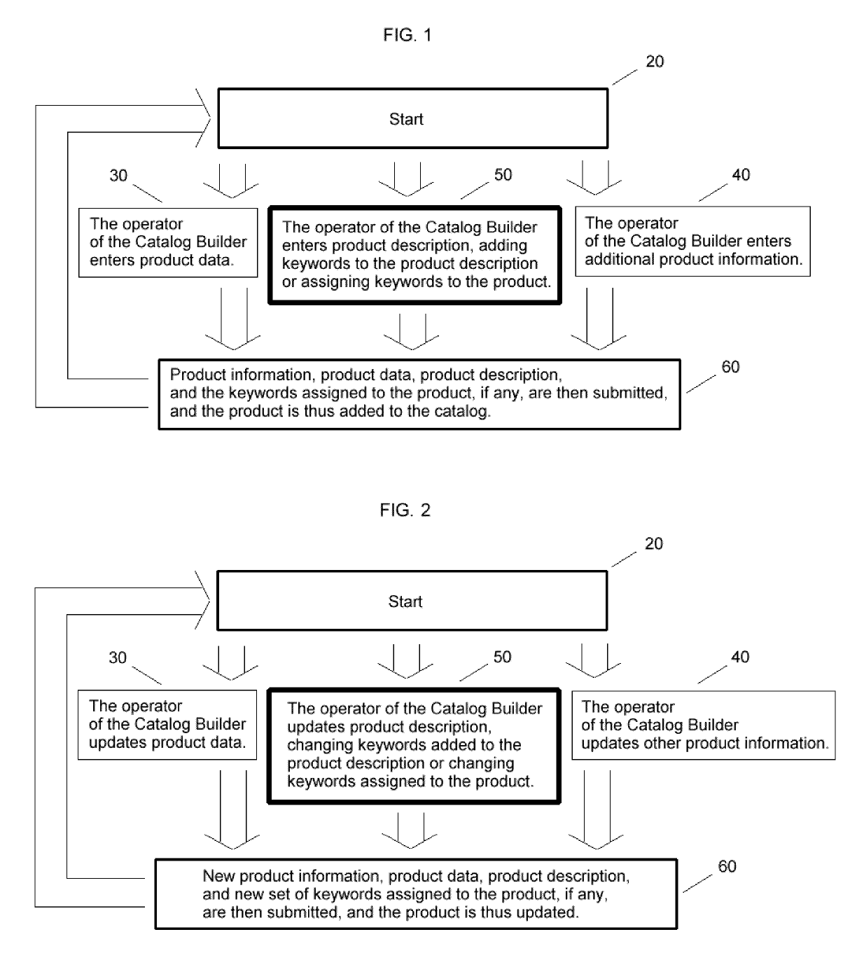

FIG. 1 is a flow diagram of an embodiment of a process performed to add products to a catalog being prepared by a Catalog Builder with an Expert System.

FIG. 2 is a flow diagram of an embodiment of a process performed to update products in a catalog using a Catalog Builder with an Expert System.

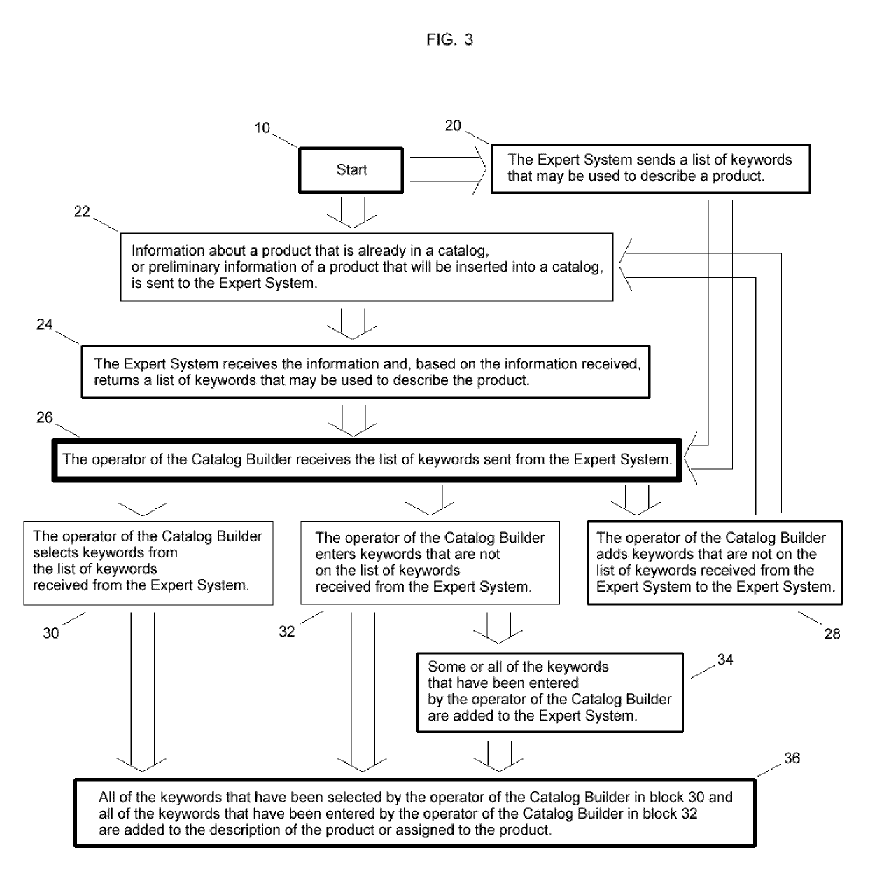

FIG. 3 is a flow diagram of an embodiment of a process performed to add keywords to the description of a product or to assign keywords to a product, in a catalog being prepared by a Catalog Builder with an Expert System. This process is part of the process to add a product to a catalog being prepared by a Catalog Builder with an Expert System (see FIG. 1). It can also be part of the process to update a product already in a catalog using a Catalog Builder with an Expert System (see FIG. 2).

### DETAILED DESCRIPTION OF THE INVENTION

Existing catalog builders rely on the operators of catalog builders to enter information about products in a catalog based on their own knowledge of the type of products in the catalog, using their own vocabulary. Better catalogs can be built if the catalog builders build catalogs with the help of an expert system.

Catalog Builder with an Expert System is a catalog builder that has a built-in expert system. A catalog builder is a software application or a web application for building product catalogs. An expert system is a knowledge-based information system. Catalog Builder with an Expert System is a software application or a web application for building product catalogs that makes use of a knowledge-based information system.

In a Catalog Builder with an Expert System, the Expert System provides catalog builder operators with keywords pertaining to products in a catalog. Using Catalog Builder with an Expert System, catalog builder operators are equipped with broader knowledge of the type of products in a catalog as well as product information communication standards. Keywords provided by the Expert System convey important information about products in a catalog which help shoppers make their purchase decisions. Keywords provided by the Expert System also help shoppers locate products within individual electronic catalogs, within individual websites, within multiple websites, or all over the Internet, through searches. Moreover, catalogs built by Catalog Builder with an Expert System provide more accurate product information which helps increase sales and reduce merchandise returns.

The Expert System contains a knowledge database that stores keywords that can be used to describe a product or help a product get discovered during a search. The knowledge database can also store the definitions of those keywords although it does not have to. Keywords and their definitions are the embodiment of the knowledge of a type of products.

A type of products can have a variety of attributes such as color, style, material, etc. Each product attribute can have different values. For example, the color of a product can be red, or green, or blue, etc. Keywords in the knowledge database represent possible values for some or all of the attributes of a type of products. The knowledge database does not contain knowledge of any particular product, but knowledge of a type of products.

The Expert System has one main function: it assists Catalog Builder operators in catalog building by making keyword suggestions to Catalog Builder operators during a product information submission process. This is accomplished by the Expert System by drawing keywords from the knowledge database and presenting them to Catalog Builder operators during a product information submission process. The keywords presented to Catalog Builder operators embodies knowledge of the type of products in the catalog that is being built, and may be used to describe a product of that type or help a product of that type get discovered during a search. The Catalog Builder operators can then select keywords from those presented to them by the Expert System and add them to the description of a product, or assign them to a product for the purpose of being included in the description of the product or helping the product get discovered during a search.

The Expert System's second function, which is optional but very useful and highly recommended, is to acquire product knowledge from the Catalog Builder operators by adding new keywords that have been entered by Catalog Builder operators during a product information submission process to the knowledge database, or by allowing Catalog Builder operators add new keywords and optionally, their definitions, to the knowledge database during a catalog building process.

During a product information submission process, after being presented with a list of keywords by the Expert System, Catalog Builder operators may select keywords from those presented by the Expert System and add them to the description of the product or assign them to the product. Meanwhile, Catalog Builder operators may also enter keywords that are not among those presented by the Expert System and add them to the description of the product or assign them to the product and, at the same time, let these new keywords be added to the knowledge database. Alternatively, Catalog Builder operators may add keywords that are not among those presented by the Expert System, and, optionally, their definitions, to the knowledge database and restart the process of adding keywords to the description of a product or assigning keywords to a product.

The Expert System's second function is optional. That is, the Expert System does not have to have this function although it is preferred that it does have this function.

Keywords and their definitions can also be added to the knowledge database by administrators of the Expert System independent from any catalog building process.

Catalog Builder with an Expert System can be used to build print catalogs, electronic catalogs, or online catalogs, including those online catalogs built for the sales of products online.

### DESCRIPTION OF THE DRAWINGS

Referring to FIG. 1, the process starts, block 20, and the operator of the Catalog Builder enters product data (such as product price), block 30, enters additional product information (such as serial number or style number), block 40, and enters product description, adding keywords to the product description or assigning keywords to the product, block 50. Product information, product data, product description, and the keywords assigned to the product, if any, are then submitted, and the product is thus added to the catalog, block 60. Upon completion of the process in block 60, the program advances to block 20 and the process of adding a product to the catalog starts over.

Referring to FIG. 2, the process starts, block 20, and the operator of the Catalog Builder updates product data, block 30, updates other product information, block 40, and updates product description, changing keywords added to the product description or changing keywords assigned to the product, block 50. New product information, product data, product description, and new set of keywords assigned to the product, if any, are then submitted, and the product is thus updated, block 60. Upon completion of the process in block 60, the program advances to block 20 and the process of updating a product in the catalog starts over.

Referring to FIG. 3, the process starts, block 10, and there are two possibilities. In one possibility, the Expert System sends a list of keywords to the operator of the Catalog Builder without receiving any information about the product that is to be inserted or to be updated, block 20. In the other possibility, preliminary information of a product that will be inserted into a catalog or information about a product that is already in a catalog or is sent to the Expert System, block 22. The Expert System receives that information, and, based on the information received, returns a list of keywords, block 24.

After receiving the list of keywords from the Expert System, block 26, the operator of the Catalog Builder may add keywords that are not on the list of keywords that have been received to the Expert System, block 28, and the system advances to block 22 where the process starts over for the same product.

Alternatively, the operator of the Catalog Builder may selects keywords from the list received from the Expert System, block 30, or enters keywords that are not on the list of keywords received from the Expert System, block 32, or does both. If keywords not on the list of keywords received from the Expert System are entered by the operator of the Catalog Builder, some or all of the keywords that have been entered may be added to the Expert System, block 34.

Finally, all of the keywords selected by the operator of the Catalog Builder from the list of keywords received from the Expert System, if any, and all of the keywords that have been entered by the operator of the Catalog Builder, if any, are then added to the description of the product or assigned to the product, block 36.

What is claimed is:

1. A method of preparing a catalog using a catalog builder and an expert system that includes the following steps:
Catalog Builder operator preparing to add a product to a catalog or update information about a product in a catalog;
The Expert System presenting to Catalog Builder operator a list of keywords; and
said Catalog Builder operator selecting keywords from said list of keywords and adding them to the description of said product or assigning them to said product.

2. The method of claim 1 wherein Catalog Builder sends some information concerning a product that is to be inserted into a catalog or a product that is already in a catalog to said Expert System; and
wherein said list of keywords is generated by said Expert System based on the information concerning said product received from Catalog Builder.

3. The method of claim 1 wherein keywords in the knowledge database of said Expert System are pertaining to only a type of products which said product belongs to;
wherein Catalog Builder is to insert a product into a catalog or to update the information about a product that is already in a catalog; and
wherein Catalog Builder sends no information concerning said product to said Expert System before said Expert System presents a list of keywords to said Catalog Builder operator.

4. The method of claim 1 wherein keywords in the knowledge database of said Expert System may be used to describe a product of the type that said product belongs to or help such a product get discovered during a search.

5. The method of claim 1 wherein keywords selected by said Catalog Builder operator from said list of keywords presented by said Expert System can be used to describe said product or help said product get discovered during a search.

6. The method of claim 1 wherein after being presented with said list of keywords by said Expert System, said Catalog Builder operator enters keywords that are not on said list of keywords presented by said Expert System, and adds them to the description of said product or assigns them to said product; and
wherein some or all of the keywords entered by said Catalog Builder operator are added to the knowledge database of said Expert System.

7. The method of claim 6 wherein the keywords that are entered by said Catalog Builder operator and are added to said Expert System can be used to describe said product or help said product get discovered during a search.

8. The method of claim 1 wherein after being presented with said list of keywords by said Expert System, said Catalog Builder operator adds keywords that are not on said list of keywords presented by said Expert System to said Expert System.

9. The method of claim 8 wherein the keywords that are added to said Expert System by said Catalog Builder operator can be used to describe said product or help said product get discovered during a search.

10. The method of claim 1 wherein keywords selected by said Catalog Builder operator are added to the description of said product.

11. The method of claim 1 wherein keywords selected by said Catalog Builder operator are assigned to said product.

12. The method of claim 11 wherein keywords assigned to said product are to be included in the description of said product.

13. The method of claim 11 wherein keywords assigned to said product are to help said product get discovered during a search.
